(19) United States
(12) Patent Application Publication
(10) Pub. No.: US 2016/0032794 A1
(43) Pub. Date: Feb. 4, 2016

(54) Flap Valve Device

(71) Applicant: Friedrich Boysen GmbH & Co. KG, Altensteig (DE)

(72) Inventors: Michael Fischer, Nagold (DE); Hayri Winter, Neubulach (DE)

(73) Assignee: Friedrich Boysen GmbH & Co. KG, Altensteig (DE)

(21) Appl. No.: 14/814,491

(22) Filed: Jul. 30, 2015

(30) Foreign Application Priority Data
Jul. 31, 2014 (DE) 102014110849.3

(51) Int. Cl. F01L 7/06; F16K 27/02; F16K 1/22

(52) U.S. Cl. CPC F01L 7/06; F16K 1/22; F16K 1/224; F16K 27/0218

(57) ABSTRACT

A flap valve device for controlling a gas flow through a tubular duct includes a valve flap which is rotatably supported at a valve housing by a valve shaft. At least two rotary bearings are provided for supporting the valve flap at the valve housing and are received in respective bearing domes. The bearing domes are arranged in the region of respective shaft leadthroughs of the valve housing which are provided for the valve shaft. At least one of the bearing domes is designed as a shaped sheet metal part separate from the valve housing.

This 35 U.S.C. §111 patent application claims the right of priority pursuant to 35 U.S.C. §119(a) and is entitled to the benefit of the filing date of German Patent Application 10-2014-110849.3, filed Jul. 31, 2014, which is hereby incorporated by reference in its entirety.

The present invention relates to a flap valve device for controlling a gas flow through a tubular duct, in particular an exhaust gas valve device for an exhaust system of a motor vehicle, having a flap which is rotatably supported by a valve shaft at a valve housing, in particular a tubular valve housing, wherein at least two rotary bearings are provided at the valve housing for supporting the valve flap and are received in respective bearing domes, with the bearing domes being arranged in the region of respective shaft leadthroughs of the valve housing provided for the valve shaft.

Such devices are, for example, used for the selective closing of exhaust gas paths in exhaust gas systems of motor vehicles. An actuating drive is typically provided by means of which the flap can be rotated between a position releasing the exhaust gas flow and a position blocking the exhaust gas flow. A partial or complete blocking of the exhaust gas flow can, for example, take place within the framework of the acoustic design of exhaust gas systems or for the direct generation of a counter-pressure. Exhaust gas valves can also be used within the framework of an exhaust gas return system for the reduction of nitrogen oxide within the engine, for example, to apply a certain quantity of exhaust gas to a low-pressure path at the fresh air side of an internal combustion engine.

In known concepts, the bearing domes important for a reliable valve support are formed as separate components to be attached to the valve housing—as a rule designed as a cast part—and are typically manufactured by cutting processes which is demanding in time and is associated with relatively high costs. In a valve housing designed as a cast part, the bearing domes can also be molded directly to the valve housing.

It is an object of the invention to simplify the manufacture of exhaust gas valves and of similar valve devices.

The object is satisfied by a flap valve device of the initially named kind, wherein at least one of the bearing domes is designed as a shaped sheet metal part separate from the valve housing.

In accordance with the invention, at least one of the bearing domes is designed as a shaped sheet metal part separate from the valve housing. A sheet metal shaping process can be effected substantially faster and less expensively than a chip-forming machining process. The invention is in particular based on the surprising recognition that a simple sheet metal shaping is sufficient to give a bearing dome for a flap valve device of the named kind the desired functionality. In contrast to bearing domes molded directly to the valve housing, separate bearing domes are simple to produce and handle.

Both bearing domes are preferably designed as shaped sheet metal parts separate from the valve housing. This allows a particularly simple production of the flap valve device. In such an embodiment, in the case of a valve housing designed as a cast part, it is in particular not necessary to include a bearing dome in the casting process.

The bearing dome designed as a shaped sheet metal part can be manufactured by a deep-drawing process or by an internal high-pressure shaping process. Deep-drawing processes are inexpensive and fast which is why they are in particular suitable for mass production. An advantage of the internal high-pressure shaping is, among others, an increased flexibility with regard to the design of the respective components.

A specific embodiment of the invention provides that the bearing dome designed as a shaped sheet metal part has a mounting section, in particular a cup-shaped mounting section, for receiving a rotary bearing and has a flange extending around the mounting section for mounting the bearing dome in contact with a wall of the valve housing. The flange can directly adjoin the mounting section or can be separated from the mounting section by an additional support section or functional section. Cup-like mounts can be manufactured in a particularly fast and inexpensive manner by means of deep-drawing. If the valve housing has a round cross-section, a flange suitable for mounting the bearing dome in contact with a wall of the valve housing must have a relatively complex shape which replicates the curvature of the valve housing. Such a shaping can be effected substantially easier by means of a sheet metal shaping process than by means of a chip-forming machining process.

In accordance with an embodiment of the invention, the valve housing is likewise designed as a shaped sheet metal part. The manufacture of the flap valve device can be simplified further in this respect.

The bearing dome designed as a shaped sheet metal part can be welded to the valve housing. A welding is in particular relatively simple when both the bearing dome and the valve housing are shaped sheet metal parts.

Alternatively, the bearing dome designed as a shaped sheet metal part can be joined to the valve housing by a shaping process, with the shaping process in particular comprising a clamping, a riveting and/or a clinching process. In such an embodiment, a welding process can be dispensed with.

The bearing dome designed as a shaped sheet metal part is preferably clinched to the valve housing by means of at least one engagement element extending from a contact surface of the bearing dome. The engagement element can be a projection projecting from the contact surface, for example, a projection in the manner of a claw. Such a projection can be easily manufactured, for example, likewise by a shaping process. A plurality of engagement elements are preferably provided at the contact surface and are arranged distributed around a mount for a rotary bearing. The bearing dome can be attached to the valve housing fast and nevertheless with a high strength by means of clinching or press joining.

A further embodiment of the invention provides that the bearing dome designed as a shaped sheet metal part is clinched to an outer side of the valve housing while forming at least one clinching projection projecting into the interior of the valve housing, wherein the clinching projection forms an abutment for the rotatable flap valve. A separate abutment element then does not have to be provided. On the contrary, the clinching projection which anyway arises during the clinching operation is intentionally positioned and advantageously used as an abutment.

It is not absolutely necessary to join the bearing dome designed as a shaped sheet metal part to the valve housing. A further embodiment of the invention rather provides that the bearing dome designed as a shaped sheet metal part is pressed toward an outer side of the valve housing by means of a spring device and is thereby held at the valve housing. In this embodiment, neither a welding process nor a clamping, riveting or clinching process is necessary.

The spring device can in this respect act—directly or indirectly—on a rotary bearing inserted into the bearing dome designed as a shaped sheet metal part from the outside to press the bearing dome toward the outer side of the valve housing. The spring device satisfies a dual function in this respect in that it presses the rotary bearing into the associated mount of the bearing dome, on the one hand, and reliably fixes the bearing dome to the valve housing via the rotary bearing, on the other hand.

To facilitate a corresponding insertion of and action on the rotary bearing, the bearing dome designed as a shaped sheet metal part can have a mount, in particular a cup-shaped mount, for a rotary bearing, said mount being open toward a side of the bearing dome remote from the housing.

A further embodiment of the invention provides that at least one abutment for the rotatable flap valve is shaped directly into the valve housing by a sheet metal shaping process. The provision of an abutment can take place in a particularly fast and simple manner by means of the sheet metal shaping process.

The abutment can in particular be shaped into the valve housing while forming an aperture, with the aperture being covered by a contact surface of the bearing dome formed as a shaped sheet metal part. In this manner a particularly simple and inexpensive manufacture of the abutment is made possible, on the one hand, and the required sealing of the valve housing is ensured, on the other hand.

Further developments of the invention are also set forth in the dependent claims, in the description and in the enclosed drawings.

The invention will be described in the following by way of example with reference to the drawings.

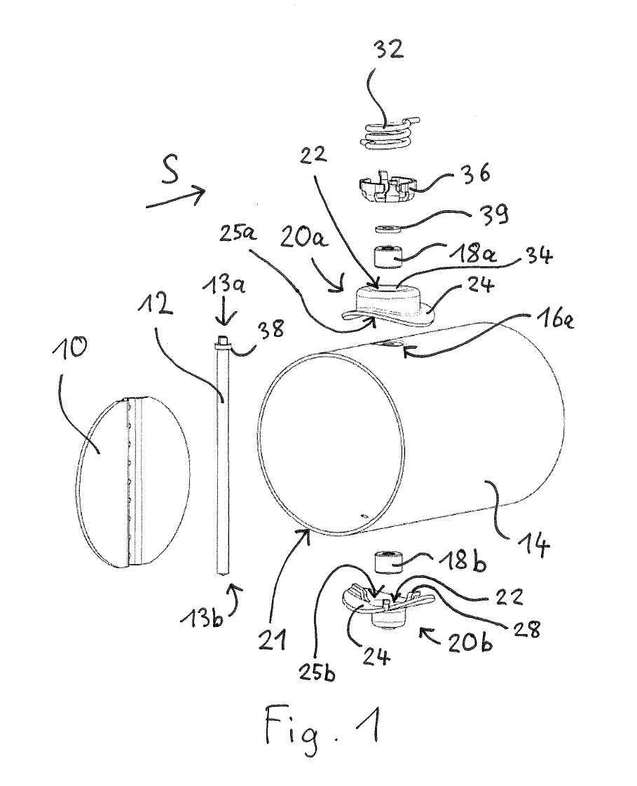

FIG. 1 is an exploded representation of a flap valve device in accordance with a first embodiment of the invention;

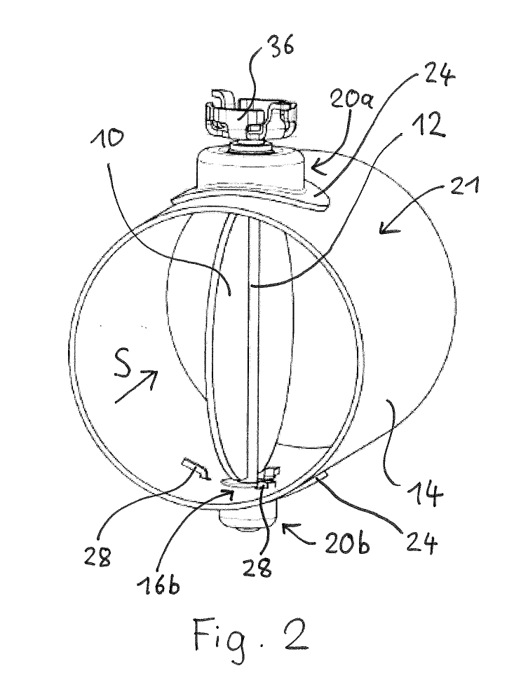

FIG. 2 shows the flap valve device in accordance with FIG. 1 in an assembled state;

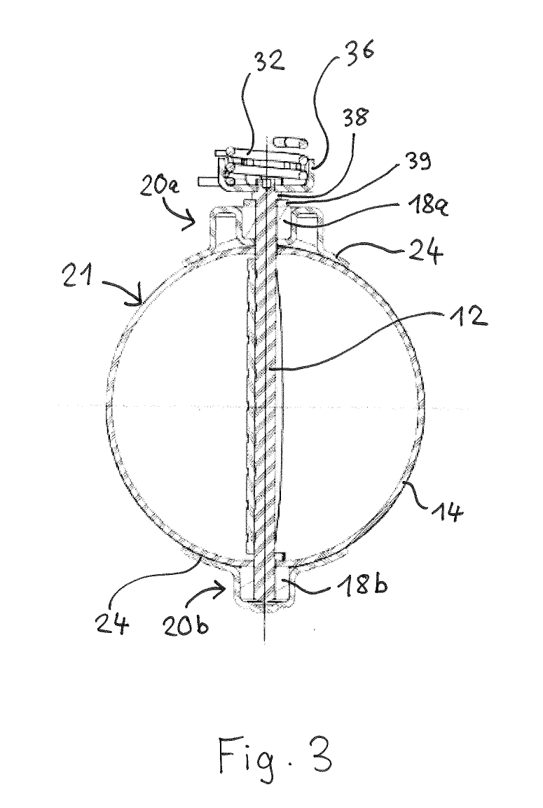

FIG. 3 is a sectional view of the flap valve device in accordance with FIG. 1;

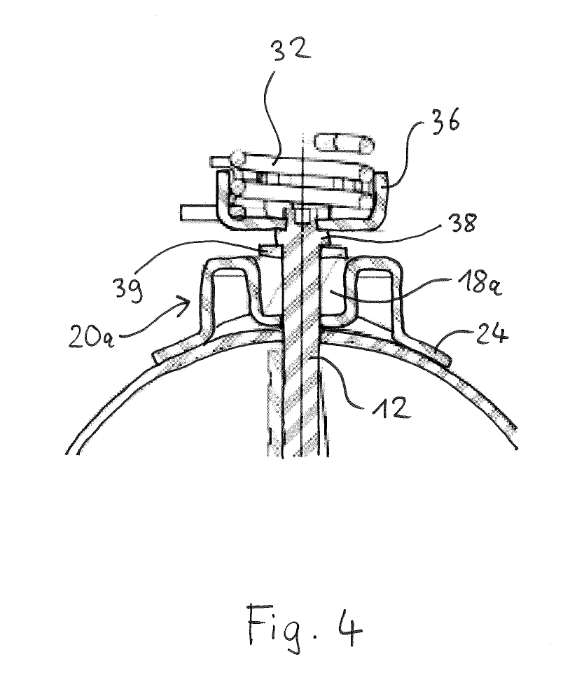

FIG. 4 shows an enlarged section of the flap valve device represented in FIG. 3 and

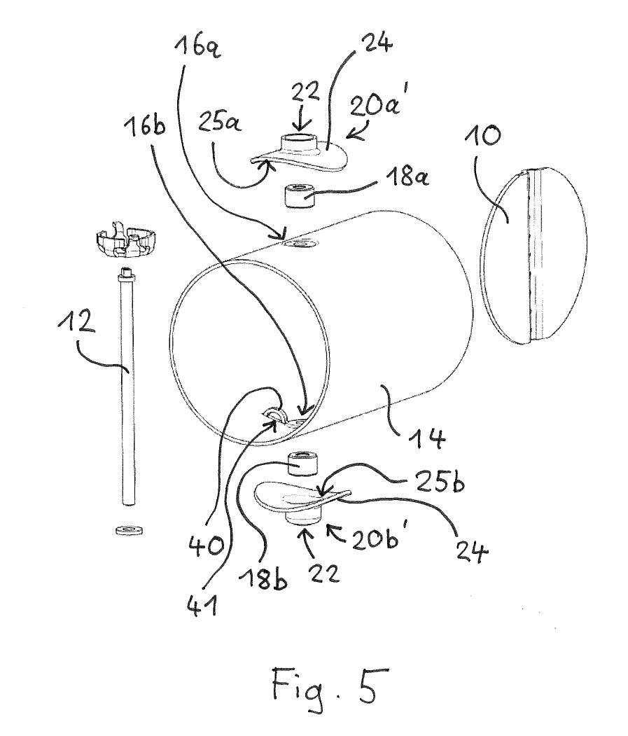

FIG. 5 is an exploded representation of a flap valve device in accordance with a second embodiment of the invention.

The flap valve device shown in FIGS. 1 to 4 includes a plate-like or disk-like valve flap 10 which is attached to a valve shaft 12. Instead of a throughgoing valve shaft 12, corresponding shaft stubs could also be attached at two opposite sides of the valve flap 10 and satisfy the function of a valve shaft together. The valve flap 10 is arranged in a tubular valve housing 14, which for example has a circular cross-section, and serves selectively to release and block a gas flow, e.g. an exhaust gas flow, led through the valve housing 14.

The shaft ends 13a, 13b of the valve shaft 12 are led out of the valve housing 14 by respective shaft leadthroughs 16a, 16b and are supported by means of rotary bearings 18a, 18b, for example by means of plain bearings or rolling element bearings. The rotary bearings 18a, 18b are received in bearing domes 20a, 20b which are arranged in the region of the shaft leadthroughs 16a, 16b at the outer side 21 of the valve housing 14. The valve flap 10 is rotatably supported at the valve housing 14 by the valve shaft 12 by means of the rotary bearings 18a, 18b in the dome bearings 20a, 20b. If the valve flap 10 is transverse to the direction of flow S of the gas flow, the gas flow is blocked. Conversely, a largely unimpeded gas flow is made possible by the valve housing 14 when the valve flap 10—as is shown in FIG. 2—is in a longitudinal orientation with respect to the direction of flow S. An actuating drive (not shown), e.g. in the form of an electric actuator or of a vacuum actuator, is in a drive-effective connection with the valve shaft 12 and ensures that the valve flap 10 adopts a desired rotary position in dependence on a control signal.

Both the valve housing 14 and the two bearing domes 20a, 20b separate from the valve housing 14 are designed as shaped sheet metal parts. The bearing domes 20a, 20b each have a cup-shaped mounting section 22 for receiving one of the rotary bearings 18a, 18b and have a flange 24 extending around the mounting section 22, said flange 24 being formed for bringing the respective bearing dome 20a, 20b into contact with the outer side 21 of the valve housing 14.

Generally, the flanges 24 can be secured against a rotation about the shaft axis by shape matching. Shape-matched features providing security against rotation are in particular arranged at the surface of the flange 24 which contacts the valve housing 14.

In the specific case of the embodiment in accordance with FIGS. 1 to 4, the flanges 24 each have a contact surface 25a, 25b facing the valve housing 14, said contact surface 25a, 25b corresponding with the shape of the outer side 21 of the valve housing 14 in a surrounding region of the shaft leadthroughs 16a, 16b. Whereas the contact surface 25a of the upper bearing dome 20a in the Figure is smooth, that is has areal contact in a through-going manner, three engagement elements 28 extend from the contact surface 25b of the lower bearing dome 20b in the Figure and are arranged distributed around the cup-shaped mounting section 22. The claw-like engagement elements 28 serve to fasten the lower bearing dome 20b to the valve housing 14 by means of a clinching process. The engagement elements 28 are, for example, led through prepared holes in the housing 14 and are subsequently bent over.

At least one of the engagement elements 28 projecting into the interior of the valve housing 14 at the end of the clinching process can form an abutment for the rotatable valve flap 10 so that an independent abutment can accordingly be dispensed with.

Whereas the lower bearing dome 20b is clinched to the valve housing 14 as described, the upper bearing dome 20a is not joined to the valve housing 14. The upper bearing dome 20a is rather held at the valve housing 14 in that a compression spring 32 presses the bearing dome 20a toward the outer side 21 of the valve housing 14. The mounting section 22 is configured at the upper bearing dome 20a such that the rotary bearing 18a can be inserted from the side remote from the valve housing 14. In other words, an opening 34 of the mounting section 22 and the contact surface 25a face opposite directions. As can in particular be recognized in FIGS. 3 and 4, the compression spring 32 arranged in a cup-shaped cage 36 presses onto the rotary bearing 18a via a collar 38 of the valve shaft 12 and via a washer 39, whereby the bearing dome 20a is pressed toward the outer side 21 of the valve housing 14. A welding or clinching process is therefore not necessary to hold the upper bearing dome 20a at the valve housing 14 in a reliable and largely sealed manner.

In the embodiment of a flap valve device in accordance with the invention represented in FIG. 5, the abutment for the valve flap 10 is not formed by an engagement element provided at the lower bearing dome 20b, but rather by an abutment element 40 shaped directly into the valve housing 14 by means of a sheet metal shaping process. The aperture 41 formed in this respect is covered gas-tight by the contact surface 25b of the lower bearing dome 20b′. In the flap valve device represented in FIG. 5, the mounting sections 22 of both bearing domes 20a′, 20b′ are open towards the valve housing 14. Both bearing domes 20a′, 20b′ are furthermore welded to the valve housing 14.

It is understood that only one of the bearing domes or both bearing domes can be welded, clinched or pressed to the valve housing in dependence on the application requirement. This means any desired combination of welding, clinching and pressing can be selected in dependence on the application situation.

The bearing domes 20a, 20b, 20a′, 20b′ can be produced in a simple and inexpensive manner by a sheet metal shaping process such as by a deep-drawing process or by an internal high-pressure shaping process. In contrast, a chip-forming machining production of the bearing domes 20a, 20b, 20a′, 20b′ represented in FIGS. 1 to 5 would be associated with comparatively high manufacturing costs. The production of the bearing domes 20a, 20b, 20a′, 20b′ by means of sheet metal shaping can take place independently of the manufacture of the valve housing 14. The invention thus allows a particularly efficient and inexpensive manufacture of flap valve devices.

### REFERENCE NUMERAL LIST

10 valve flap
12 valve shaft
13a, 13b shaft end
14 valve housing
16a, 16b shaft leadthrough
18a, 18b rotary bearing
20a, 20a′, 20b, 20b′ bearing dome
21 outer side
22 mounting section
24 flange
25a, 25b contact surface
28 engagement element
32 compression spring
34 opening
36 cage
38 collar
39 washer
40 abutment element
41 aperture
S direction of flow

1. A flap valve device for controlling a gas flow through a tubular duct, the device having a valve flap (10) which is rotatably supported by a valve shaft (12) at a valve housing (14), in particular a tubular valve housing,
wherein at least two rotary bearings (18a, 18b) are provided at the valve housing (14) for supporting the valve flap (10) and are received in respective bearing domes (20a, 20b, 20a′, 20b′), with the bearing domes (20a, 20b, 20a′, 20b′) being arranged in the region of respective shaft leadthroughs (16a, 16b) of the valve housing (14) provided for the valve shaft (12), at least one of the bearing domes (20a, 20b, 20a′, 20b′) being designed as a shaped sheet metal part separate from the valve housing (14).

2. A flap valve device in accordance with claim 1, wherein the device is an exhaust gas valve device for an exhaust system of a motor vehicle,

3. A flap valve device in accordance with claim 1, wherein both bearing domes (20a, 20b, 20a′, 20b′) are designed as shaped sheet metal parts separate from the valve housing (14).

4. A flap valve device in accordance with claim 1, wherein the at least one bearing dome (20a, 20b, 20a′, 20b′) designed as a shaped sheet metal part is manufactured by one of a deep-drawing process and an internal high-pressure shaping process.

5. A flap valve device in accordance with claim 1, wherein the at least one bearing dome (20a, 20b, 20a′, 20b′) designed as a shaped sheet metal part has a mounting section (22), for receiving a rotary bearing (18a, 18b) and has a flange (24) extending around the mounting section (22) for mounting the bearing dome (20a, 20b, 20a′, 20b′) in contact with a wall of the valve housing (14).

6. A flap valve device in accordance with claim 1, wherein the mounting section is cup-shaped,

7. A flap valve device in accordance with claim 1, wherein the flap valve device (14) is designed as a shaped sheet metal part.

8. A flap valve device in accordance with claim 1, wherein the at least one bearing dome (20a′, 20b′) designed as a shaped sheet metal part is welded to the valve housing (14).

9. A flap valve device in accordance with claim 1, wherein the bearing at least one dome (20a, 20b) designed as a shaped sheet metal part is joined to the valve housing (14) by a shaping process.

10. A flap valve device in accordance with claim 9, wherein the shaping process is at least one of a clamping process, a riveting process and a clinching process.

11. A flap valve device in accordance with claim 10, wherein the at least one bearing dome (20b) designed as a shaped sheet metal part is clinched to the valve housing (14) by means of at least one engagement element (28) extending from a contact surface (25b) of the bearing dome (20b).

12. A flap valve device in accordance with claim 10, wherein the at least one bearing dome (20b) designed as a shaped sheet metal part is clinched to an outer side (21) of the valve housing (14) while forming at least one clinch projection projecting into the interior of the valve housing (14), with the clinch projection forming an abutment for the rotatable valve flap (10).

13. A flap valve device in accordance with claim 1, wherein the at least one bearing dome (20a) designed as a shaped sheet metal part is pressed toward an outer side (21) of the valve housing (14) by means of a spring device (32) and is thereby held at the valve housing (14).

14. A flap valve device in accordance with claim 13, wherein the spring device (32) acts on a rotary bearing (18a) inserted into the bearing dome (20a) designed as a shaped sheet metal part from the outside to press the bearing dome (20a) toward the outer side (21) of the valve housing (14).

15. A flap valve device in accordance with claim 1, wherein the bearing dome (20a) designed as a shaped sheet metal part has a mount, for a rotary bearing (18a), said mount being open toward a side of the bearing dome (20a) remote from the housing.

16. A flap valve device in accordance with claim 15, wherein the mount is cup-shaped.

17. A flap valve device in accordance with claim 1, wherein at least one abutment for the rotatable valve flap (10) is formed by a projection of the valve housing (14), said projection projecting into the valve housing.

18. A flap valve in accordance with claim 17, wherein said projection is formed by a sheet metal shaping process.

19. A flap valve device in accordance with claim 17, wherein the abutment is shaped into the valve housing (14) while forming an aperture (41), with the aperture (41) being covered by a contact surface (25b) of the bearing dome (20b′) formed as a shaped sheet metal part.
